(19) United States
(12) Patent Application Publication
(10) Pub. No.: US 2010/0141743 A1
(43) Pub. Date: Jun. 10, 2010

(54) RED PHOSPHOR FOR DISPLAY DEVICE AND DISPLAY DEVICE INCLUDING SAME

(75) Inventors: Jay-Hyok SONG, Suwon-si (KR); Yu-Mi Song, Suwon-si (KR); Ji-Hyun Kim, Suwon-si (KR); Seon-Young Kwon, Suwon-si (KR); Do-Hyung Park, Suwon-si (KR); Yoon-Chang Kim, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/632,162

(22) Filed: Dec. 7, 2009

(30) Foreign Application Priority Data
Dec. 8, 2008 (KR) 10-2008-0124094

(51) Int. Cl. H04N 13/04; H01J 63/04; C09K 11/78; C09K 11/81

(52) U.S. Cl. 348/51; 313/486; 252/301.4 R; 252/301.5; 252/301.4 P; 348/E13.075

(57) ABSTRACT

A red phosphor is represented by the following Formula 1.

(Y₁₋ₓMₓ)_{1-z}(V_{y}M′_{1-y})O₄:Eu_{z} [Formula 1]

wherein, M is an element selected from the group consisting of Gd, In, La, Sc, Lu, and combinations thereof, M′ is an element selected from the group consisting of P, Nb, W, and combinations thereof, 0.00≦x≦1.00, 0.40<y≦1.00, and 0.01≦z≦0.20. A display device includes the red phosphor.

### CROSS-REFERENCE TO RELATED APPLICATION

This application claims the benefit of Korean Patent Application No. 10-2008-0124094 filed Dec. 8, 2008, in the Korean Intellectual Property Office, the disclosure of which is incorporated herein by reference.

### BACKGROUND OF THE INVENTION

1. Field of the Invention

Aspects of the present invention relate to a red phosphor for a display device and a display device including the same. More particularly, aspects of the present invention relate to a red phosphor for a display device having a short decay time, and a display device including the same.

2. Description of the Related Art

A plasma display panel operates based on a discharge phenomenon of a mixed gas of xenon (Xe) and neon (Ne) injected in a panel that is discharged to display images. In the discharge phenomenon, a high-energy-excited phosphor layer emits visible rays when vacuum ultraviolet (VUV) rays having a wavelength of 147 or 172 nm generated during the discharge operation are irradiated onto phosphors of the phosphor layer. This plasma display panel includes a front substrate, a rear substrate, and discharge cells partitioned by barrier ribs between the two substrates. The discharge cells each are coated with a red, green, or blue phosphor layer and selectively produce a plasma discharge to display visible light generated from the phosphor layer.

A stereoscopic image using a plasma display panel is realized by dividing a 1 TV field (16.7 msec) into two subfields, respectively producing left and right stereoscopic images, and then projecting the stereoscopic images to left and right eyes of an audience wearing goggles. The goggles worn by the audience are mounted with optical shutters on the left and right sides to project the selected stereoscopic image signal to both eyes by connecting the left and right subfields. However, since the 1 TV field is divided into halves to provide two subfields, it is desirable that the phosphor layers therein have a better decay time characteristic than that of a plasma display panel for other general purposes. Particularly, when a plasma display panel includes a phosphor having a long 1/10 decay time, it may have a stereoscopic image with remarkably deteriorated resolution and distinction due to a crosstalk phenomenon such as acquiring a left subfield image by the right eye. (Y,Gd)BO₃:Eu is known as a common red phosphor for a plasma display panel, and has a decay time in a range of 7 to 9 msec. When only the (Y,Gd)BO₃:Eu phosphor is used to prepare a red phosphor layer, the resolution of a stereoscopic image may deteriorate due to the crosstalk phenomenon.

Recently, research on a red phosphor having a short decay time and good luminescence has been carried out in order to provide a three-dimensional stereoscopic image for next generation virtual three-dimensional stereoscopic multimedia, which may be applied to fields of telecommunications, broadcasting, medical, education, training, military, gaming, animation, virtual reality, CAD, industrial technology, and so on.

### SUMMARY OF THE INVENTION

One embodiment of the present invention provides a red phosphor for a display device having a short decay time.

Another embodiment of the present invention provides a display device including the phosphor.

The embodiments of the present invention are not limited to the above technical purposes, and a person of ordinary skill in the art may understand other technical purposes.

According to an embodiment of the present invention, a red phosphor for a display device represented by the following Formula 1 is provided.

(Y₁₋ₓMₓ)_{1-z}(V_{y}M′_{1-y})O₄:Eu_{z} [Formula 1]

wherein,

M is an element selected from the group consisting of Gd, In, La, Sc, Lu, and combinations thereof,

M′ is an element selected from the group consisting of P, Nb, W, and combinations thereof,
≦x≦1.00, 0.40<y≦1.00, and 0.01≦z≦0.20.

According to an aspect of the present invention, in the above Formula 1, M is Gd and M′ is P.

According to an aspect of the present invention, 0.00≦x≦0.1.

According to an aspect of the present invention, P is M′.

According to an aspect of the present invention, 0.50≦y≦0.8.

According to an aspect of the present invention, the red phosphor include a first phosphor that is a compound represented by the above Formula 1 and a second phosphor that is a compound represented by the following Formula 2.

(Y₁₋ₐGdₐ)_{1-b}BO₃:Eu_{b} [Formula 2]
wherein, 0.2≦a≦0.3 and 0.02<b<0.10.

According to another embodiment of the present invention, there is provided a display device including one or more discharge cells coated with a phosphor layer that includes the red phosphor.

Hereinafter, further embodiments of the present invention will be described in detail.

When a red phosphor according to an aspect of the present invention is applied to a display device that provides a three-dimensional stereoscopic image, the red phosphor may contribute to excellent image production due to its short decay time.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partially exploded view of a plasma display panel (PDP) according to one embodiment of the present invention;

FIG. 2 is graph showing fluorescent spectra of the Y_{0.95}VO₄:Eu_{0.05} phosphor according to Example 1;

FIG. 3 is a graph showing fluorescent spectra of the Y_{0.9}(V_{0.5}P_{0.5})O₄:Eu_{0.1} phosphor according to Example 4; and

FIG. 4 is a graph showing fluorescent spectra of the Y_{0.9}(V_{0.4}P_{0.6})O₄:Eu_{0.1} phosphor according to Comparative Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain aspects of the present invention by referring to the figures.

Aspects of the present invention relate to a red phosphor having a short decay time and that is applied to a display device, and in particular, to a display device that may provide a three-dimensional stereoscopic image, such as a plasma display panel (PDP), a cathode ray tube, and the like. In particular, the red phosphor according to aspects of the present invention may be most usefully applied to a plasma display device.

A Y_{0.9}(V_{0.4}P_{0.6})O⁴:Eu_{0.10} phosphor having a shorter decay time than the (Y,Gd)BO₃:Eu phosphor has been developed as a red phosphor. This Y_{0.9}(V_{0.4}P_{0.6})O₄:Eu_{0.10} phosphor has a decay time of 3.7 msec, which is lower than that of the (Y,Gd)BO₃:Eu phosphor. However, it would be desirable to have a phosphor with an even shorter decay time than the Y_{0.9}(V_{0.4}P_{0.6})O₄:Eu_{0.10} phosphor in order to prevent the cross-talk phenomenon.

The red phosphor according to the aspects of the present invention has short 1/10 decay time so that it does not have shortcomings in which phosphors having a long 1/10 decay time have a stereoscopic image with remarkably deteriorated resolution and distinction due to a crosstalk phenomenon, such as, acquiring a left subfield image by the right eye.

The red phosphor according to aspects of the present invention may include a compound represented by the following Formula 1.

(Y₁₋ₓMₓ)_{1-z}(V_{y}M′_{1-y})O₄:Eu_{z} [Formula 1]
wherein,
M is an element selected from the group consisting of Gd, In, La, Sc, Lu, and combinations thereof,
M′ is an element selected from the group consisting of P, Nb, W, and combinations thereof,
0.00≦x≦1.00, 0.40<y≦1.00, and 0.01≦z≦0.20.

The red phosphor represented by Chemical Formula 1 has a vanadium (V) mole ratio in a range of 0.40 to 1.00. When the V mole ratio is within this range, the red phosphor has a decay time of 3.5 ms or less. In particular, when the red phosphor of Chemical Formula 1 has a V mole ratio ranging from 0.5 to 1.00, the red phosphor may have a short decay time ranging from 1.8 to 3.3 ms. Accordingly, a red image may be prevented from being inadvertently observed in a stereoscopic display device.

In the above Formula 1, when x is not 0, in other words, when the phosphor includes M, M may be selected from the group consisting of Gd, In, La, Sc, Lu, and a combination thereof. As a specific, non-limiting example, M may be Gd. When M is Gd in the red phosphor of Chemical Formula 1, the red phosphor has a luminance that is about 1 to 2% better than that of a red phosphor that includes In, La, Sc, or Lu.

As a non-limiting example, x may have a value of 0.00≦x≦0.1. When x has a value within this range, the phosphor may have about 1 to 2% further improved luminance.

As a non-limiting example, y may have a value of 0.50≦y≦0.8. As a more specific, non-limiting example, M′ may be P, and y may be within a range of 0.50≦y≦0.8. In the above Formula 1, when a phosphor includes P as M′ and y within the range, the luminance decrease of the phosphor may be suppressed, while the decay time of the phosphor may be decreased.

According to an embodiment of the present invention, a red phosphor may include a phosphor represented by the above Formula 1 as a first phosphor and a phosphor represented by the following Formula 2 as a second phosphor.

(Y₁₋ₐGdₐ)_{1-b}BO₃:Eu_{b} [Formula 2]
wherein 0.2≦a≦0.3 and 0.02<b<0.10.

As a non-limiting example, the first and second phosphors may be mixed in a mixing ratio of 95:5 to 40:60 wt %. As a more specific, non-limiting example, the first and second phosphors may be mixed in a mixing ratio ranging from 80:20 to 40:60 wt %. As an even more specific, non-limiting example, the first and second phosphors may be mixed in a ratio of 80:20 to 60:40 wt %. When the second phosphor is included within this range, the red phosphor may maintain its decay time characteristics and have improved luminance.

According to the embodiment of the present invention, a red phosphor has a short decay time and an excellent color coordinate characteristic and may be usefully applied to a display device. In particular, the red phosphor may be applied to a display operated at a high speed of 160 Hz or, more generally, at a high speed of 120 Hz or more, such as a device providing three-dimensional stereoscopic images. In particular, a red phosphor according to aspects of the present invention has a decay time of 3.5 ms or less, or more specifically, a decay time in a range of 1.8 to 3.3 ms. Accordingly, the red phosphor may be usefully applied to a three-dimensional stereoscopic image device. Herein, the term “decay time” refers to the amount of time it takes for a phosphor to have 1/10 less amount of light generated therefrom after the phosphor stops being excited.

According to another embodiment of the present invention, there is provided a display device including a red phosphor as described above. As an example of the display device, a plasma display panel (PDP) is illustrated hereinafter.

Herein, it is to be understood that where is stated herein that one layer is “formed on” or “disposed on” a second layer, the first layer may be formed or disposed directly on the second layer or there may be intervening layers between the first layer and the second layer. Further, as used herein, the term “formed on” is used with the same meaning as “located on” or “disposed on” and is not meant to be limiting regarding any particular fabrication process.

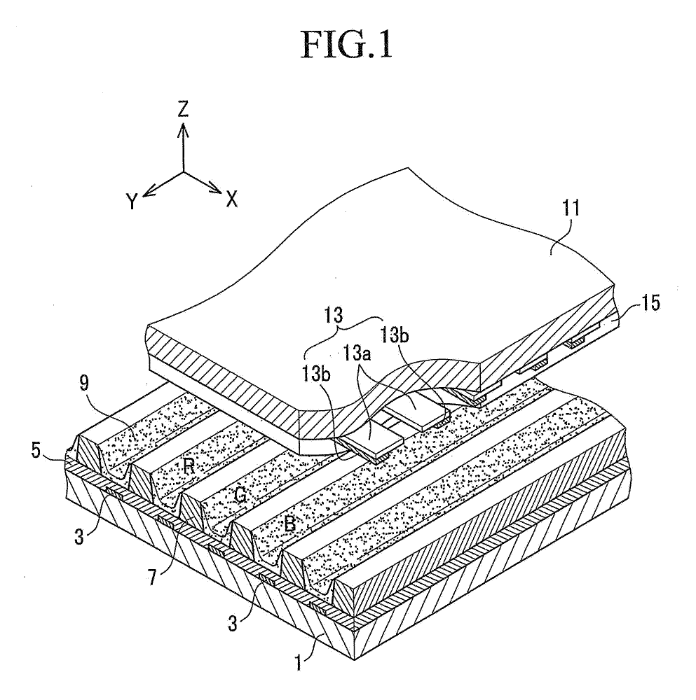

FIG. 1 is a partial exploded perspective view of a plasma display panel. As shown in FIG. 1, the plasma display panel includes a first substrate 1 (rear substrate) and a second substrate 11 (front substrate) that are disposed substantially in parallel each other with a predetermined distance therebetween.

On the surface of the first substrate 1, a plurality of address electrodes 3 are disposed in one direction (the Y direction in the drawing), and a first dielectric layer 5 is disposed covering the address electrodes 3. A plurality of barrier ribs 7 are formed on the first dielectric layer 5 among the address electrodes 3 at a predetermined height to form a discharge space.

The barrier ribs 7 may be formed in any shape as long as the shape of the barrier ribs partitions the discharge space. In addition, the barrier ribs 7 may be formed in diverse patterns. For example, the barrier ribs 7 may be formed in an open-type pattern such as a stripe configuration, or in a closed type pattern such as a waffle, a matrix, or a delta shape. Also, the closed-type barrier ribs may be formed such that a horizontal cross-section of the discharge space is a polygon such as a quadrangle, a triangle, or a pentagon, or a circle or an oval.

Red (R), green (G), and blue (B) phosphor layers 9 are disposed in discharge cells R, G, and B formed between the barrier ribs 7. The red phosphor layer includes the above-described red phosphor.

Display electrodes 13, each including a pair of a transparent electrode 13a and a bus electrode 13b, are disposed in a direction crossing the address electrodes 3 (X direction in the drawing) on one surface of a second substrate 11 facing the first substrate 1. A dielectric layer 15 is disposed on the surface of the second substrate 11 and covers the display electrodes 13.

Discharge cells are formed at positions where the address electrodes 3 of the first substrate 1 are crossed by the display electrodes 13 of the second substrate 11. The discharge cells are filled with a discharge gas.

With the above-described structure, address discharge is performed by applying an address voltage (Va) to a space between the address electrodes 3 and the display electrodes 13. When a sustain voltage (Vs) is applied to a space between a pair of the display electrodes 13, an excitation source generated from the sustain discharge excites a corresponding phosphor layer 9, so that the phosphor layer 9 emits visible light through the second substrate 11, which is transparent. The excitation source representatively includes vacuum ultraviolet (VUV) rays.

The following examples illustrate aspects of the present invention in more detail. The following examples merely illustrate aspects of the present invention, and the scope of the present invention is not limited by the examples.

### EXAMPLES 1 TO 8 AND COMPARATIVE EXAMPLES 1 AND 2

For each of Examples 1 to 8 and Comparative Examples 1 and 2, Y₂O₃, Eu₂O₃, V₂O₅, and P₂O₅ were mixed according to a stoichiometric method to prepare the respective composition provided in the following Table 1. Then, 3.0 wt % of H₃BO₃ as a flux was added to the mixture.

The mixture was fired at 1200° C. for 2 hours. The fired product was ground with a ball mill, cleaned, dried, and sieved to prepare a phosphor.

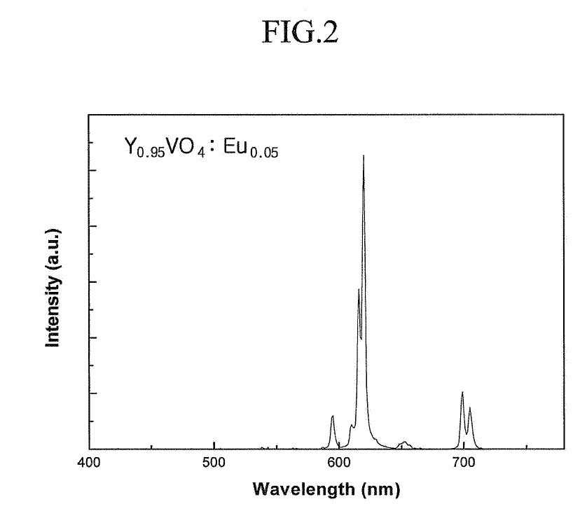

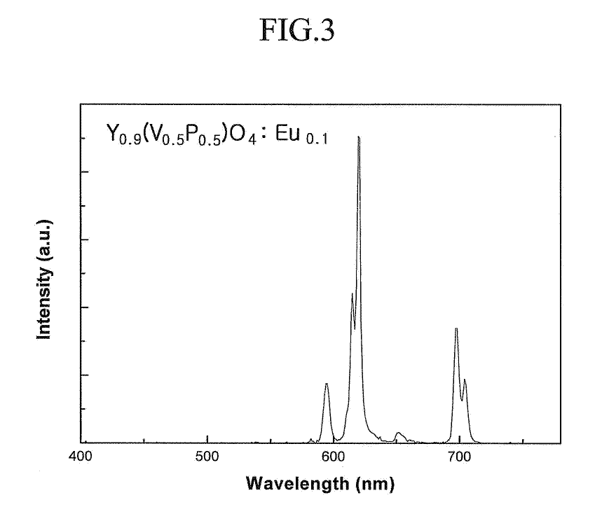

The fluorescent spectrum of the phosphor was measured. The results for the phosphors of Examples 1 and 4 are respectively provided in FIGS. 2 and 3.

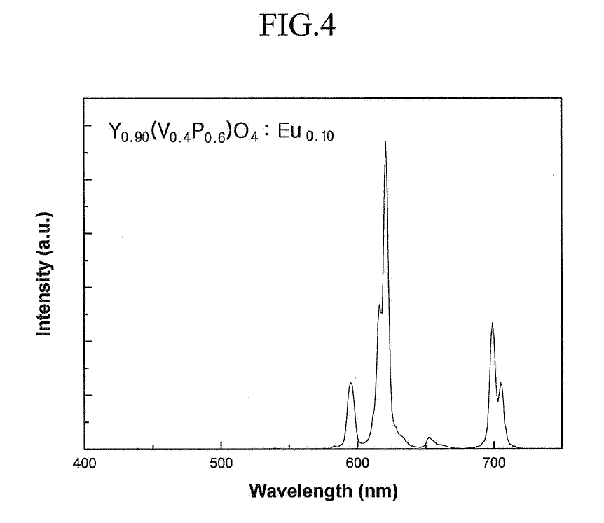

As shown in FIG. 2, the Y_{0.95}VO₄:Eu_{0.05} phosphor of Example 1 has a maximum fluorescent strength at 620 nm that is 9.09 times as high as at a peak at 595 nm. Accordingly, the phosphor of Example 1 may be usefully applied to a plasma display panel (PDP) including an Ne-cut filter (blocking light of about 590 nm), which is used to improve color purity. As shown in FIG. 3, the Y_{0.9}(V_{0.5}P_{0.5})O₄:Eu_{0.1} phosphor of Example 4 has fluorescent strength at 620 nm that is 4.97 times as high as a peak at 595 nm (peak intensity ratio of 595 nm:620 nm:700 nm=1:4.97:1.89). FIG. 4 shows the fluorescent spectrum of the Y_{0.9}(V_{0.4}P_{0.6})O₄:Eu_{0.10} phosphor of Comparative Example 1 (peak intensity ratio of 595 nm:620 nm:700 nm=1:4.65:1.9). As shown in FIGS. 3 and 4, the more V that is included in the phosphor, the stronger the fluorescent strength at 620 nm becomes. This shows that the probability of transition from ⁵D₀ to ⁷F₂ of Eu³⁺ increases as the amount of V in the phosphor increases.

In addition, the 1/10 decay time, relative luminance, and CIE color coordinate of the phosphors were measured. The results are provided in the following Table 1. In general, a red phosphor has better quality as the CIE x value comes closer to 0.67 and the CIE y value comes closer to 0.33 in a CIE color coordinate system. This color coordinate as a reference was compared with the color coordinate measurements. The relative luminance was calculated, when a phosphor of Comparative Example 1 was considered to be 100% of luminance as a reference.

TABLE 1

| | | 1/10 | CIE color | | Relative |
|---|---|---|---|---|---|
| | | decay | coordinate | | luminance |
| | Composition | time (ms) | x | y | (%) |
| Comparative | Y_{0.90}(V_{0.4}P_{0.6})O₄:Eu_{0.10} | 3.7 | 0.667 | 0.332 | 100.0 |
| Example 1 | | | | | |
| Example 1 | Y_{0.95}VO₄:Eu_{0.05} | 1.8 | 0.673 | 0.325 | 70.2 |
| Example 2 | Y_{0.95}(V_{0.8}P_{0.2})O₄:Eu_{0.05} | 2.2 | 0.671 | 0.326 | 80.0 |
| Example 3 | Y_{0.90}(V_{0.6}P_{0.4})O₄:Eu_{0.10} | 2.8 | 0.672 | 0.327 | 87.5 |
| Comparative | Y_{0.90}(V_{0.2}P_{0.8})O₄:Eu_{0.10} | 3.9 | 0.621 | 0.337 | 100.3 |
| Example 2 | | | | | |
| Example 4 | Y_{0.90}(V_{0.5}P_{0.5})O₄:Eu_{0.10} | 3.3 | 0.671 | 0.326 | 92.5 |
| Example 5 | Y_{0.90}(V_{0.7}P_{0.3})O₄:Eu_{0.10} | 2.5 | 0.672 | 0.327 | 84.3 |
| Example 6 | (Y_{0.95}Gd_{0.05})_{0.90}(V_{0.5}P_{0.5})O₄:Eu_{0.10} | 2.5 | 0.672 | 0.327 | 93.4 |
| Example 7 | (Y_{0.9}Gd_{0.1})_{0.90}(V_{0.5}P_{0.5})O₄:Eu_{0.10} | 2.4 | 0.673 | 0.325 | 92.8 |
| Example 8 | (Y_{0.85}Gd_{0.15})_{0.90}(V_{0.5}P_{0.5})O₄:Eu_{0.10} | 2.4 | 0.671 | 0.327 | 85.6 |

As shown in Table 1, the phosphors of Examples 1 to 8, which have a V mole ratio of more than 0.4, have a very short 1/10 decay time of less than 3.7 ms. In addition, the phosphors of Examples 1 to 8 have excellent color coordinates. The phosphors of Examples 1 to 2 have a lower relative luminance than the phosphors of Comparative Examples 1 and 2, but their luminance is maintained at an appropriate level of 70 to 80%. The phosphors of Examples 3 to 7, in which Y was partly replaced with Gd, have an excellent relative luminance ranging from 84 to 93%. The phosphor of Comparative Example 1, with a V mole ratio of 0.4, has a long decay time of 3.7 ms. The phosphor of Comparative Example 2, with a V mole ratio of 0.2, has a degraded color coordinate characteristic as well as a very long decay time of 3.9 ms.

As shown in Table 1, when P mole ratio of the (Y₁₋ₓMₓ)_{1-z}(V_{y}M′_{1-y})O₄:Eu_{z} phosphor is increased from 0 to 0.4, the decay time of the phosphor increases from 1.8 msec to 2.8 msec but the CIE x value decreases from 0.673 to 0.672.

### EXAMPLES 9 TO 10 AND COMPARATIVE EXAMPLES 3 TO 5

For each of Examples 9 to 10 and Comparative Examples 3 to 5, a red phosphor was prepared by mixing Y_{0.95}VO_{0.4}:Eu_{0.05} as a first phosphor R1 and (Y_{0.75}Gd_{0.25})_{0.95}BO₃:Eu_{0.05} as a second phosphor R2 according to the composition in the following Table 2.

1/10 decay time, CIE color coordinate, and relative luminance of the phosphors were measured. The results are provided in the following Table 2. The relative luminance was calculated regarding luminance of the first phosphor as 100% as a reference.

TABLE 2

| | Composition | | | | | |
|---|---|---|---|---|---|---|
| | and mixing | | | CIE color | | Relative |
| | ratio (wt %) | | Decay | coordinate | | luminance |
| | R1 | R2 | time (ms) | x | y | (%) |
| Example 3 | 100 | 0 | 1.8 | 0.673 | 0.325 | 100 |
| Example 9 | 80 | 20 | 2.2 | 0.671 | 0.337 | 141.4 |
| Example 10 | 60 | 40 | 2.9 | 0.667 | 0.331 | 276.3 |
| Reference | 40 | 60 | 3.5 | 0.656 | 0.344 | 206.5 |
| Example 1 | | | | | | |
| Reference | 20 | 80 | 5.8 | 0.651 | 0.349 | 229.8 |
| Example 2 | | | | | | |
| Reference | 0 | 100 | 8.7 | 0.649 | 0.350 | 248.8 |
| Example 3 | | | | | | |

As shown in Table 2, luminance may be improved by mixing a Y_{0.95}VO_{0.4}:Eu_{0.05} phosphor with a short decay time and a common (Y_{0.75}Gd_{0.25})_{0.95}BO₃:Eu_{0.05} phosphor with excellent red luminescence characteristics. Herein, when the common (Y_{0.75}Gd_{0.25})_{0.95}BO₃:Eu_{0.05} phosphor is included in an amount of less than 60 wt %, the mixture phosphor had a decay time of less than 3.5 msec and about 107% improved luminance. When the second phosphor was increasingly included from 0 wt % to 60 wt %, the mixture phosphor had a little increase in decay time from 1.8 to 3.5 msec. Since this decay time is suitable for realizing a stereoscopic image, it can be seen that the inclusion of up to 60 wt % of the second phosphor maintains the desired decay time characteristic and also remarkably improves the luminance.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A red phosphor for a display device, comprising a compound represented by the following Formula 1:
(Y₁₋ₓMₓ)_{1-z}(V_{y}M′_{1-y})O₄:Eu_{z} [Formula 1]
wherein
M is an element selected from the group consisting of Gd, In, La, Sc, Lu, and combinations thereof,
M′ is an element selected from the group consisting of P, Nb, W, and combinations thereof,
0.00≦x≦1.00, 0.40<y≦1.00, and 0.01≦z≦0.20.

2. The red phosphor of claim 1, wherein the M is Gd.

3. The red phosphor of claim 1, wherein 0.00≦x≦0.1.

4. The red phosphor of claim 1, wherein the M′ is P.

5. The red phosphor of claim 1, wherein 0.5≦y≦0.7.

6. The red phosphor of claim 1, wherein the red phosphor comprises a first phosphor that is the compound represented by the above Formula 1 and a second phosphor that is a compound represented by the following Formula 2:
(Y₁₋ₐGdₐ)_{1-b}BO₃:Eu_{b} [Formula 2]
wherein 0.2≦a≦0.3 and 0.02<b<0.10.

7. The red phosphor of claim 6, wherein the first phosphor and the second phosphor are present in the red phosphor in a ratio of 95:5 to 40:60 wt %.

8. The red phosphor of claim 7, wherein the first phosphor and the second phosphor are present in the red phosphor in a ratio of 80:20 to 40:60 wt %.

9. The red phosphor of claim 8, wherein the first phosphor and the second phosphor present in the red phosphor in a ratio of 80:20 to 60:40 wt %.

10. The red phosphor of claim 1, wherein the display device is a device that provides a three-dimensional stereoscopic image.

11. The red phosphor of claim 1, wherein the red phosphor has a decay time of 3.5 ms or less.

12. The red phosphor of claim 11, wherein the red phosphor has a decay time of 1.8 to 3.5 ms.

13. A display device comprising:
one or more discharge cells coated with a phosphor layer that includes a red phosphor comprising a compound represented by the following Formula 1:
(Y₁₋ₓMₓ)_{1-z}(V_{y}M′_{1-y})O₄:Eu_{z} [Formula 1]
wherein
M is an element selected from the group consisting of Gd, In, La, Sc, Lu, and combinations thereof,
M′ is an element selected from the group consisting of P, Nb, W, and combinations thereof,
0.00≦x≦1.00, 0.40<y≦1.00, and 0.01≦z≦0.20.

14. The display device of claim 13, wherein the M is Gd.

15. The display device of claim 13, wherein 0.00≦x≦0.1.

16. The display device of claim 13, wherein the M′ is P.

17. The display device of claim 13, wherein 0.5≦y≦0.7.

18. The display device of claim 13, wherein the red phosphor comprises a first phosphor that is a compound represented by the above Formula 1 and a second phosphor that is a compound represented by the following Formula 2:
(Y₁₋ₐGdₐ)_{1-b}BO₃:Eu_{b} [Formula 2]
wherein 0.2≦a≦0.3 and 0.02<b<0.10.

19. The display device of claim 18, wherein the first phosphor and the second phosphor are present in the red phosphor in a ratio of 95:5 to 40:60 wt %.

20. The display device of claim 19, wherein the first phosphor and the second phosphor are present in the red phosphor in a ratio of 80:20 to 40:60 wt %.

21. The display device of claim 19, wherein the first phosphor and the second phosphor are present in the red phosphor in a ratio of 80:20 to 60:40 wt %.

22. The display device of claim 13, wherein the red phosphor has a decay time of 3.5 ms or less.

23. The display device of claim 22, wherein the red phosphor has a decay time of 1.8 to 3.5 ms.

24. The display device of claim 13, wherein the display device is a device that provides a three-dimensional stereoscopic image
